(19) United States
(12) Patent Application Publication
(10) Pub. No.: US 2026/0149351 A1
(43) Pub. Date: May 28, 2026

(54) MULTIPHASE CONVERTER AND MOTOR

(71) Applicant: ABB SCHWEIZ AG, Baden (CH)

(72) Inventors: Mikhail Khanin, Fort Smith, AR (US); Timothy Lee Brinkley, Fort Smith, AR (US); Jaron Lee Robison, Barling, AR (US); Clint McBride, Cameron, OK (US)

(21) Appl. No.: 18/957,388

(22) Filed: Nov. 22, 2024

(51) Int. Cl. H02M 1/00; H02K 11/33; H02M 1/42; H02M 7/04; H02M 7/537

(52) U.S. Cl. CPC H02M 1/0043; H02K 11/33; H02M 1/0067; H02M 1/4208; H02M 7/04; H02M 7/537

(57) ABSTRACT

An electric motor system includes an alternating current (AC) to direct current (DC) converter configured to convert a single-phase AC power signal to a DC power signal. The electric motor systems also includes a DC to AC converter coupled to the AC to DC converter and configured to change the DC power signal to a multi-phase power source having at least four AC power signals that are phase-shifted relative to each other. The electric motor has at least four phases, where each phase in the at least four phases is electrically coupled to an output that provides of one of the four AC power signals from the DC to AC converter. Various other systems and methods are also disclosed.

### SUMMARY

As will be described in greater detail below, the present disclosure generally relates to apparatuses, systems, and method for converting single-phase power to multi-phase power. In some aspects, the techniques described herein relate to an electric motor system including an alternating current (AC) to direct current (DC) converter configured to convert a single-phase AC power signal to a DC power signal. The electric motor system also includes a DC to AC converter coupled to the AC to DC converter and configured to change the DC power signal to a multi-phase power source having at least four AC power signals that are phase-shifted relative to each other. The electric motor may have at least four phases, where each phase in the at least four phases is electrically coupled to an output that provides of one of the four AC power signals from the DC to AC converter.

In some aspects, the techniques described herein relate to an electric motor system, where the electric motor includes an asynchronous motor. In some aspects, the techniques described herein relate to an electric motor system, where the electric motor includes a synchronous motor. In some aspects, the techniques described herein relate to an electric motor system, where the DC to AC converter is configured to change the DC power signal to a multi-phase power supply by changing the DC power signal to six AC power signals that are phase shifted relative to each other. In such examples, the electric motor may have at least six phases, where each phase in the at least six phases is electrically coupled to an output that provides one of the six AC power signals from the DC to AC converter.

In some aspects, the techniques described herein relate to an electric motor system, where the DC to AC converter includes two three-phase inverters configured to have 30 degrees of electrical separation from each other. In some aspects, the techniques described herein relate to an electric motor system, where the AC to DC converter includes a single-phase rectifier with power-factor correction. In some aspects, the techniques described herein relate to an electric motor system, where the AC to DC converter includes an active front end configured to enable the electric motor to function as an electric generator. In some aspects, the techniques described herein relate to an electric motor system, where the AC to DC converter and the DC to AC converter are mechanically coupled to a housing of the electric motor.

In some aspects, the techniques described herein relate to a method including the step of coupling an alternating current (AC) to direct current (DC) converter to a DC to AC converter. In this example, the AC to DC converter is configured to convert a single-phase AC power signal to a DC power signal, and the DC to AC converter is configured to change the DC power signal to a multi-phase power supply having at least four AC power signals that are phase-shifted relative to each other. The method also includes the step of coupling the multi-phase power supply to an electric motor by coupling each output that provides one of the at least four AC power signals to a different phase of the electric motor. In some aspects, the method further includes the step of mechanically coupling the DC to AC converter and the AC to DC converter to a housing of the electric motor.

In some aspects, the techniques described herein relate to a method including the step of converting a single-phase alternating current (AC) power signal to a direct current (DC) power signal. The method also includes the step of converting the DC power signal to a multi-phase power supply having at least four AC power signals that are phase-shifted relative to each other and transmitting the at least four AC power signals to at least four phases of an electric motor. In some aspects, converting the DC power signal to the AC power signal includes changing the DC power signal to six AC power signals that are phase shifted relative to each other.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary system for converting single-phase power to multi-phase power according to various embodiments of the present disclosure.

FIG. 2 is a block diagram of an exemplary DC to multi-phase AC converter according to various embodiments of the present disclosure.

FIG. 3 is a block diagram of a set of inverters according to various embodiments of the present disclosure.

FIG. 4 is a block diagram of an exemplary control scheme according to various embodiments of the present disclosure that use two field-oriented controllers and two three-phase pulse-width modulators.

FIG. 5 is a block diagram of another exemplary control scheme according to various embodiments of the present disclosure that use a single field-oriented controller.

FIG. 6 is a block diagram of another exemplary control scheme according to various embodiments of the present disclosure that use a six-phase pulse-width modulator.

FIG. 7 is a block diagram of another exemplary control scheme according to various embodiments of the present disclosure that use two direct-torque controllers.

FIG. 8 is a block diagram of another exemplary control scheme according to various embodiments of the present disclosure that use a single direct torque controller.

FIG. 9 is a block diagram of another exemplary control scheme according to various embodiments of the present disclosure that use a single direct torque controller and a six-phase pulse-width modulator.

FIG. 10 is a block diagram of an example of an implementation of embodiments described herein.

FIG. 11 shows a method for coupling a multi-phase converter to a motor.

FIG. 12 shows a method for converting single-phase power to multi-phase power for powering a motor according to various embodiments of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Single-phase motors, widely utilized in various applications, inherently lack the capability to generate a rotating magnetic field necessary for self-starting. Upon application of power, the motor experiences equal positive and negative sequence torques, resulting in cancellation and no net rotation. To overcome this limitation, auxiliary methods are employed to initiate rotation in a preferred direction.

One technique involves incorporating a start capacitor connected to an auxiliary winding, electrically displaced by 90 degrees. This configuration induces positive sequence currents, facilitating initial motor acceleration. As the motor gains speed, the positive sequence torque overcomes the negative sequence torque, allowing continuous operation. The start capacitor is then mechanically switched out of the circuit to prevent overheating.

The mechanical components integral to this starting mechanism, specifically the single-phase switch and capacitor, are often the primary failure points of these motors. Common failures include switch malfunction, where the switch welds shut, preventing disconnection of the start capacitor and capacitor failure, where continuous operation leads to overheating and eventual capacitor venting.

In contrast to single-phase motors, multi-phase motors typically do not require a start capacitor to initiate rotation. This is because multi-phase power inherently generates a rotating magnetic field, enabling self-starting. In other words, the phase difference between supply currents of different phases creates a rotating magnetic field in the stator windings, and this rotating field induces currents in the rotor, generating torque without auxiliary starting mechanisms. Thus, multi-phase motors may not have the failure issues associated with a start capacitor. Unfortunately, using a multiphase motor may not be an option when only single-phase power is available.

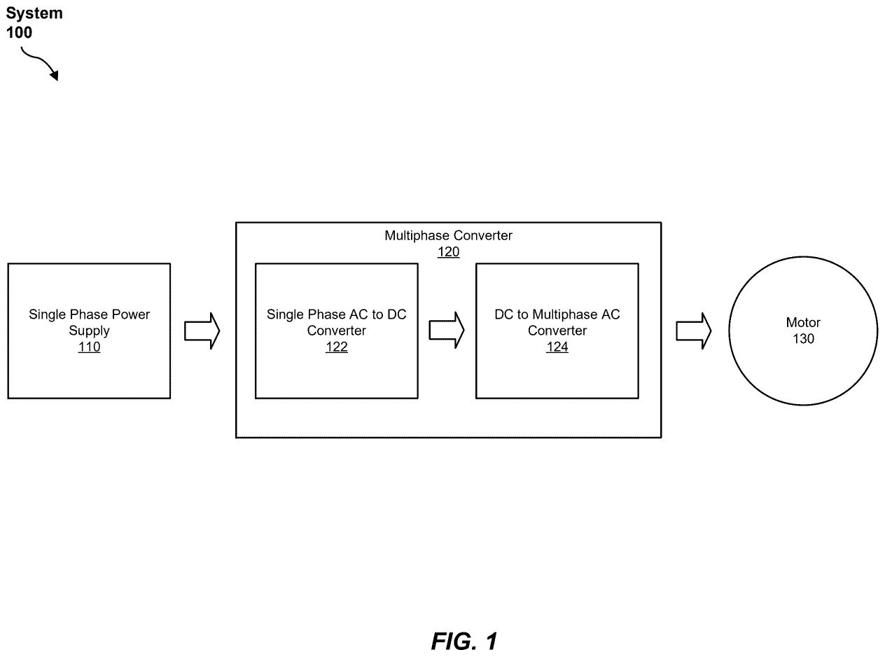

The systems discussed herein may address these and/or other disadvantages of traditional systems by enabling use of a multi-phase motor with a single-phase power supply. For example, the systems presented herein may enable the use of a more efficient multi-phase motor (e.g., a six-phase motor) in place of a less-efficient single-phase motor. FIG. 1 shows an example of this type of system 100 and includes a single-phase power supply 110 that supplies a single-phase, alternating current (AC) power signal. A multiphase converter 120 is electrically coupled to single-phase power supply 110 and includes a single-phase AC to direct current (DC) converter 122 that converts the single-phase AC power signal to a DC power signal. Multiphase converter 120 also includes a DC to multiphase AC converter that converts the DC power signal to a multi-phase AC power signal. DC to multiphase AC converter 124 is coupled to a motor 130 and provides the multiphase power signal to motor 130.

AC to DC converter 122 may be any suitable type or form of converter and may be implemented in a variety of ways. For example, AC to DC converter 122 may be a rectifier, such as a passive rectifier (e.g., a bridge rectifier, a center-tapped rectifier, etc.) or an active rectifier (e.g., an active front end, an insulated gate bipolar transistor rectifier, etc.). When AC to DC converter 122 includes an active front end, AC to DC converter 122 enables bidirectional power exchange, which can provide regenerative power to a grid. In such embodiments, AC to DC converter 122 may also provide power factor correction, which may be implemented via passive components, active components (e.g., a buck-boost converter), or in any other suitable manner. Furthermore, an active front end may enable motor 130 to function as a generator.

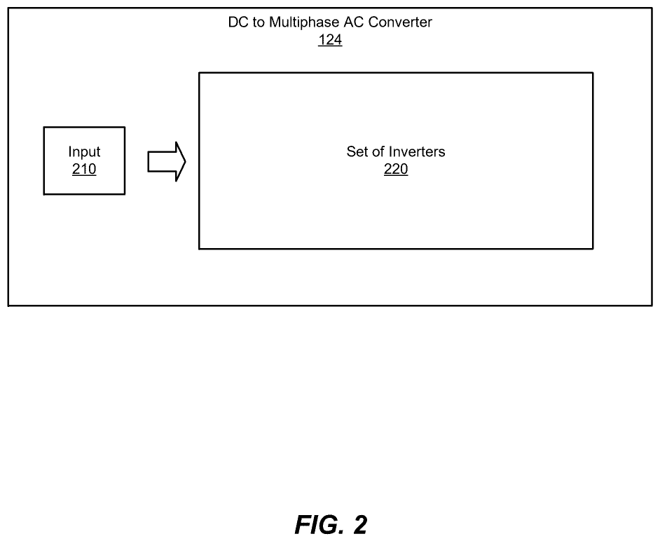

As with AC to DC converter 122, DC to multiphase converter 124 may be implemented in a variety of ways. FIG. 2 shows one example of a multiphase DC to AC converter 124, which includes an input 210 that receives DC power and a set of inverters 220 electrically coupled to the input. Input 210 may be any suitable type or form of electrical terminal or connector and may be made of any conductive material. Set of inverters 220 may include one or more inverters for converting the DC power signal received via the input to a multiphase AC power signal. The inverters in set of inverters 220 may use any suitable switching circuitry and filters and may be implemented with various types of switching (e.g., pulse-width modulation, sine wave, etc.).

Set of inverters 220 may convert a DC power signal to various multiphase output signals. In some examples, set of inverters 220 converts a DC power signal a four-phase AC power signal. In some examples, set of inverters 220 converts a DC power signal to a five-phase AC power signal. In some examples, set of inverters 220 converts a DC power signal to a six-phase AC power signal. In some examples, set of inverters 220 converts a DC power signal to a multi-phase AC power signal that has more than six phases.

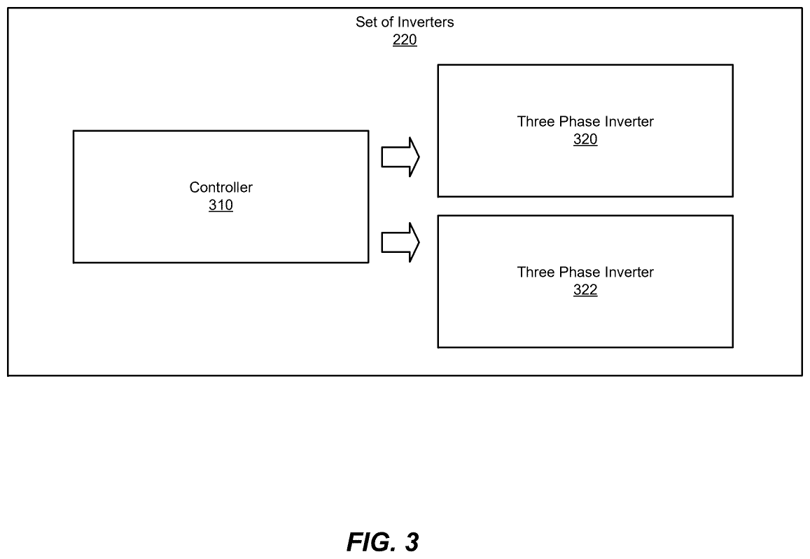

In some examples, set of inverters 220 may include a three-phase inverter 320, a three-phase inverter 322, and a controller 310 that is coupled to both three-phase inverters 320 and 322, as shown in FIG. 3. Three-phase inverters 320 and 322 may be implemented using various topologies, including a three-level neutral point clamped topology, a two-level topology, a multi-level topology, a matrix topology, etc. Controller 310 may regulate the timing of three-phase inverters 320 and 322 to provide a six-phase output. In some examples, three-phase inverters 320 and 322 have 30 degrees of electrical separation from each other. This 30-degree separation helps to reduce torque ripple and provide a smoother power delivery compared to a standard three-phase system. Furthermore, by carefully designing the winding arrangement, six-phase systems can significantly reduce the presence of certain harmonic currents.

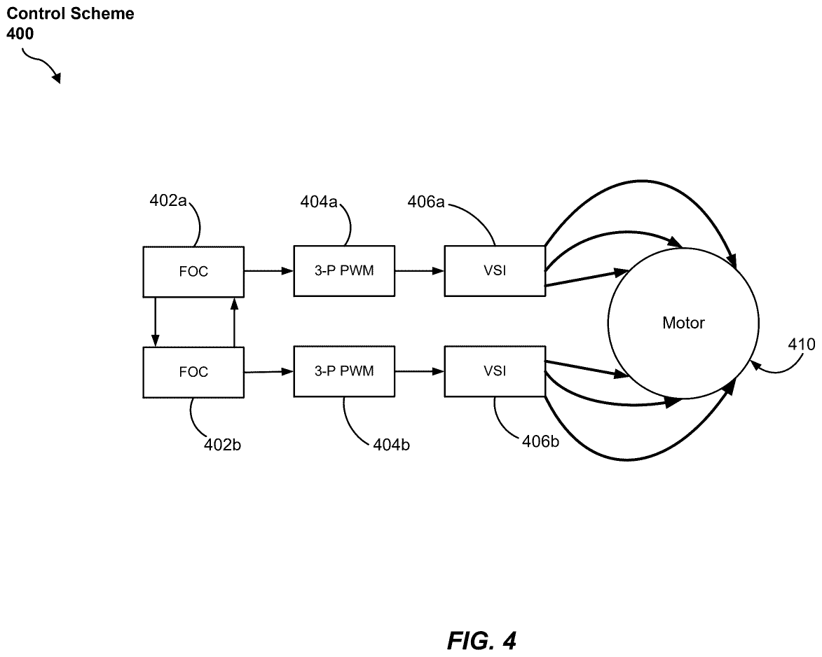

Various different control schemes can be used to control a multi-phase converter that converts DC power to multi-phase AC power, and FIGS. 4-9 provide examples of such control schemes. Control schemes other that those illustrated in FIGS. 4-9 can also be used to control a multi-phase converter.

FIG. 4 shows one example of a control scheme 400 implemented by a controller. Control scheme 400 includes two dual field-oriented controls (FOCs) 402a and 402b, which are designed to control the magnetic field generated by the stator of motor 410 by sending a control signal to pulse-width modulators (PWMs) 404a and 404b. PWMs 404a and 404b modulate the control signal and provide a modulated control signal to voltage-source inverters (VSIs) 406a and 406b to control the switches (e.g., IGBTs, MOSFETS) of VSIs 406a and 406b in a manner that causes VSIs 406a and 406 b to each output three-phase AC signals that are offset (e.g., by 30 degrees) relative to each other.

In some embodiments, FOCs 402a and 402b operate through a sequential process that involves first measuring current of motor 410. FOCs 402a and 402b then transform these measurements into a synchronous reference frame, and control calculations determine the required voltage vectors to achieve desired torque and flux. Independent three-phase pulse width modulators (3-P PWM) 404a and 404b may apply these voltage vectors received from FOCs 402a and 402b to motor 410 via VSIs 406a and 406b, respectively. This control process may provide high efficiency through controlled magnetic field control, fast dynamics for quick responses to load or speed changes, smooth operation with reduced vibration and noise, and precise control for accurate speed, torque, and position regulation.

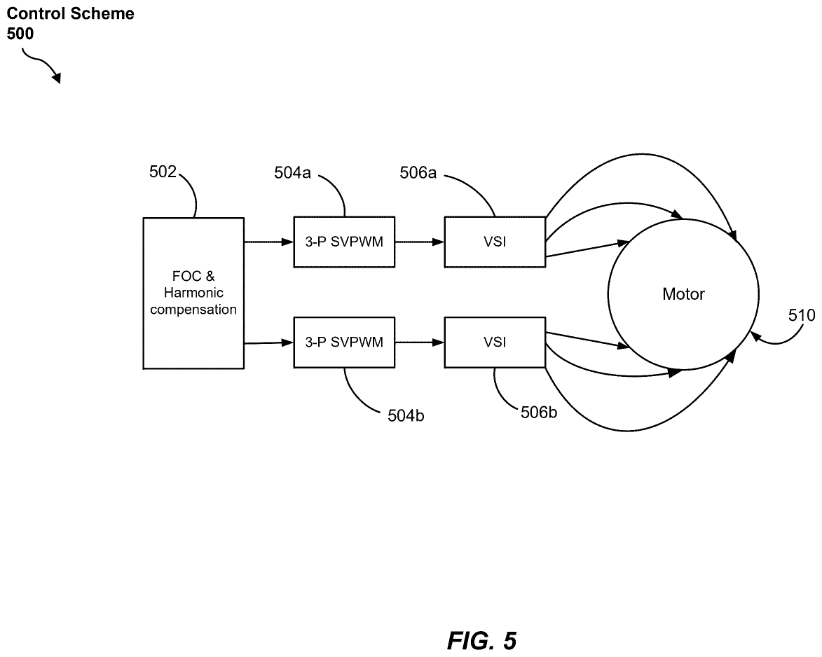

FIG. 5 shows another example control scheme 500 for controlling a multiphase converter. In contrast to FIG. 4, the example shown in FIG. 5 includes a single FOC 502 with two independent three-phase space vector pulse width modulators (3-P SVPWM) 504a and 504b that are coupled to two VSIs 506a and 506b, respectively. VSIs 506a and 506b are controlled by FOC 502 and three-phase SVPWMs 504a and 504b to provide six-phase power to motor 510. In this example, FOC 502 may provide harmonic compensation by anticipating harmonic distortion, monitoring and correcting harmonic distortion, and/or adjusting to changing harmonic conditions. Furthermore, using SVPWMs may also provide lower harmonics, higher efficiency (e.g., via reduced switching losses, lower computation times, etc.), and may reduce stress on DC link components. SVPWMs also work well with vector control schemes of FOCS.

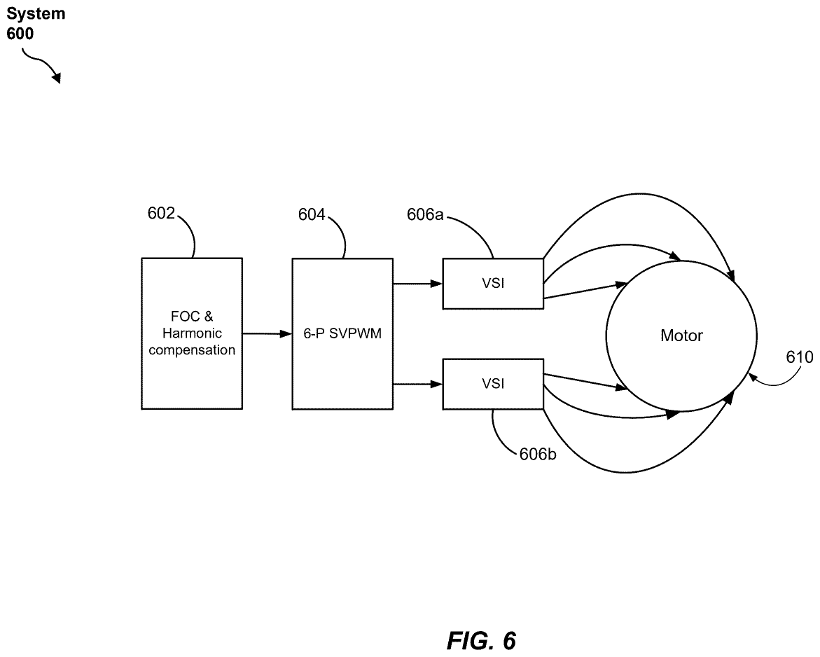

FIG. 6 shows an example control scheme that is similar to the control scheme of FIG. 5 but uses a single six-phase SVPWM instead of two three-phase SVPWMs. As shown, control scheme 600 includes a single FOC 602 with a single six-phase SVPWM 604, and SVPWN is coupled to the switches of VSIs 606a and 606b to cause VSIs 606a and 606b to provide multi-phase power to motor 610. In this example, FOC 602 uses a single synchronous reference frame, which may reduce complexity relative to FOCs that use two reference frames.

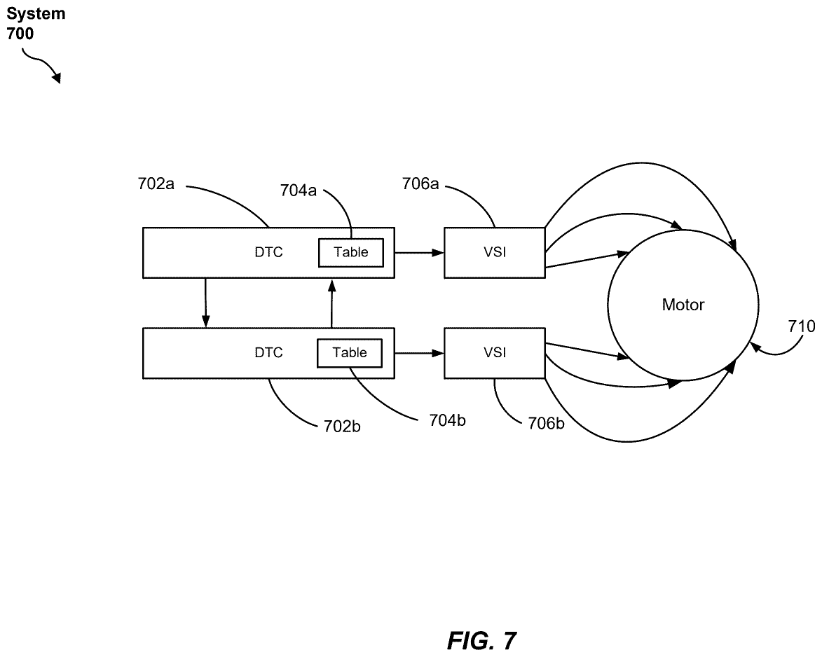

FIG. 7 shows another control scheme 700 includes at least two direct torque controllers (DTCs) 702a and 702b that use lookup tables to control the switching of VSI 706a and 706b such that VSIs 706a and 706b output a six-phase alternating current signal to a motor 710. DTCs 702a and 702b may estimate torque of motor 710 from measured currents and voltages and may regulate torque and flux within predetermined bands by selecting switching vectors for torque and flux control. These switching vectors are stored in three-phase switching tables 704a and 704b. In other words, tables 704a and 704b are lookup tables that enable DTCs 702a and 702b reduce computational load by using reference parameters to come up with control vectors instead of using complex calculations. DTCs 702a and 702b may also provide improved control accuracy and faster torque response relative to some other control schemes. As shown in FIG. 7, DTCs 702a and 702b may include two independent switching tables.

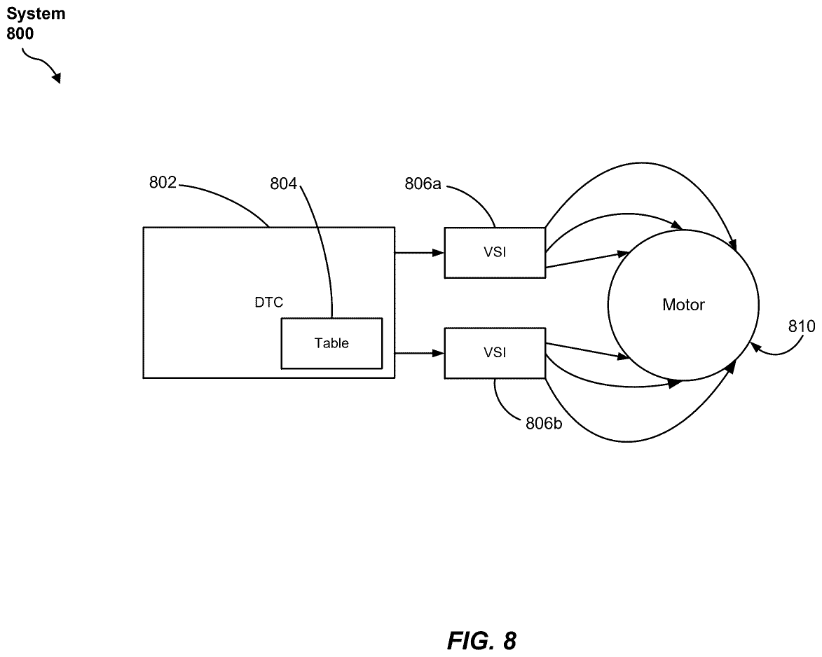

FIG. 8 shows a switching scheme 800 that is similar to switching scheme 700, but instead of two DTCs, scheme 800 includes a single DTC 802 with a six-phase switching table 804. By using a six-phase switching table, DTC 802 is able to directly control switching within two VSIs 806a and 806b in a manner that causes them to convert a DC power signal to a six-phase AC power signals provided to motor 810.

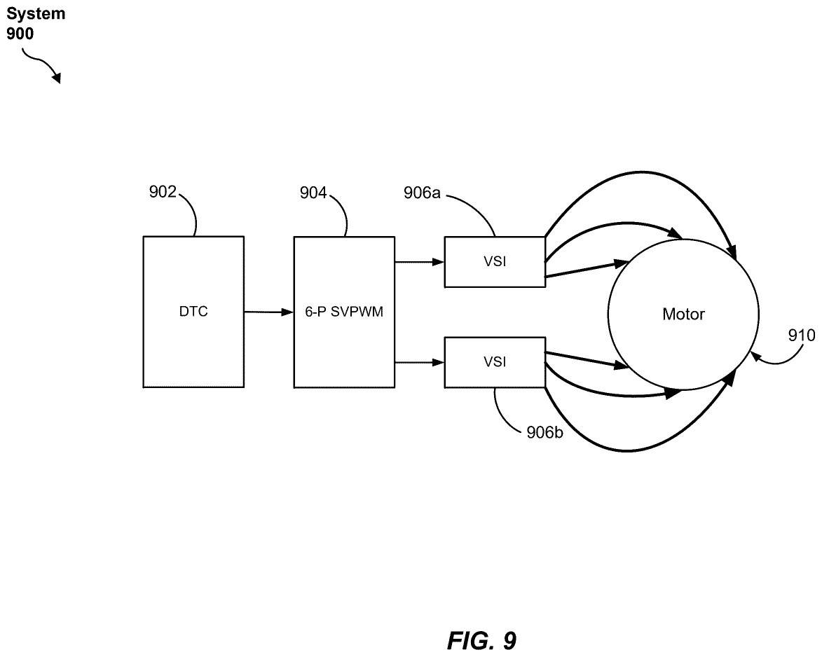

FIG. 9 shows a switching scheme 900 that implements both a DTC 902 and a six-phase SVPWM 904 to cause VSIs 906a and 906b to convert a DC power signal to a six-phase AC power that is provided to motor 910. In this example, instead of using a multi-phase switching table to control VSIs directly, DTC 902 uses a single-phase switching table to output a single-phase control signal, and six-phase SVPWM uses pulse-width modulation to convert the control signal from DTC 802 to switching signals that cause motor 910 to provide a six-phase AC output.

In the example shown in FIG. 9, DTC 902 may implement a deadbeat control method where the control strategy attempts to achieve a “deadbeat” response, meaning the system's output rapidly reaches the desired value with minimal overshoot and settling time, essentially eliminating any steady-state error in a single control cycle. In some examples, this is achieved through precise prediction of the system's behavior and applying the necessary control action to achieve the desired result immediately.

DTC 902 may also implement a feedback linearization control method, which is a control strategy that combines direct torque control with feedback linearization techniques, essentially applying a mathematical transformation to a nonlinear system like a motor to make it behave like a linear system. In this way, DTC 902 may provide improved control performance by reducing torque and flux ripples while maintaining the advantages of traditional direct torque control.

While the control schemes of FIGS. 4-9 show controllers and other components for converting a DC power signal into a six-phase AC power signal, similar schemes can be used to converter a DC power signal into a four-phase AC power signal, a five-phase AC power signal, or a power signal that has more than six phases. Similarly, while FIGS. 4-10 show configurations that use two three-phase inverters, similar control schemes can be used with any other suitable number of converters.

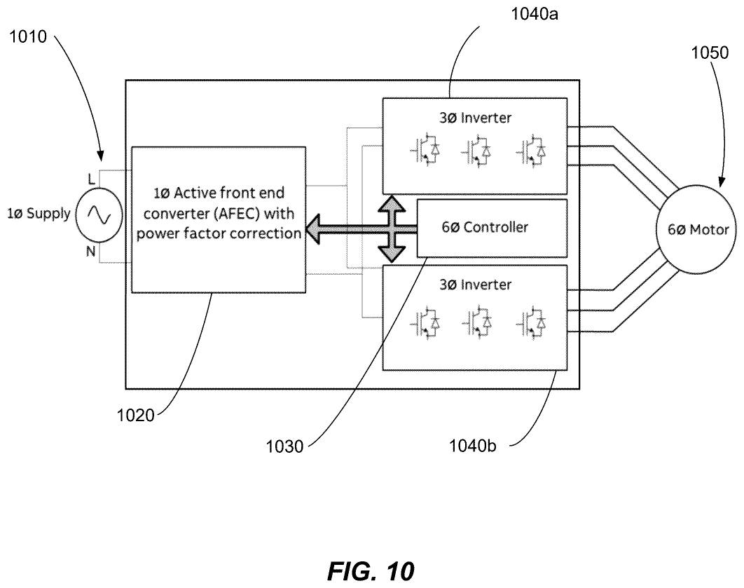

As an example of how the controllers shown in FIGS. 4-9 may be implemented to control a six-phase motor, FIG. 10 shows a single-phase power supply 1010 electrically coupled to an active front end converter (AFEC) 1020 to provide single-phase power to provide AFEC 1020. AFEC 1020 has power factor correction and is coupled to three-phase inverters 1040a and 1040b to provide a DC power signal to three-phase inverters 1040a and 1040b, and six-phase controller 1030 controls inverters 1040a and 1040b to create a six-phase AC power signal that is supplied to six-phase motor 1050.

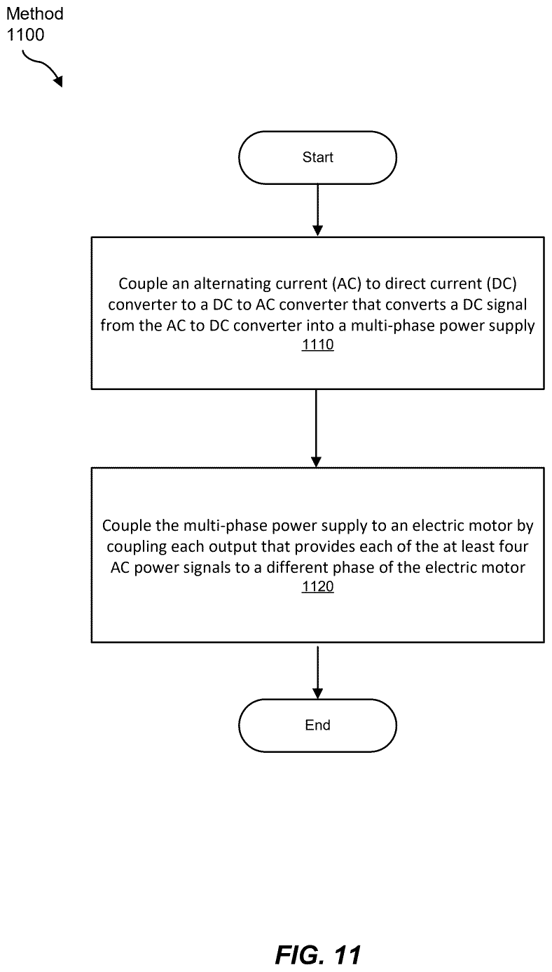

FIG. 11 shows a method 1100 for coupling a multi-phase converter to a motor. As shows in step 1110, an AC to DC converter is coupled to a DC to AC converter. The AC to DC converter is configured to convert a single-phase AC power signal to a DC power signal, and the DC to AC converter is configured to change the DC power signal to a multi-phase power supply having at least four AC power signals that are phase-shifted relative to each other. At step 1120, the multi-phase power supply is coupled to an electric motor by coupling each output that provides one of the at least four AC power signals to a different phase of the electric motor.

The multi-phase power supply may be coupled to an electric motor in any suitable manner. In some examples, the multi-phase converter may be coupled to an electric motor by attaching it to any suitable component of the electric motor. In some examples, the multiphase converter may be mounted directly to a motor housing. The multi-phase converter may also be housed with a motor's terminal box or within a separate enclosure attached to a housing of the motor. As another example, the multi-phase converter may also be attached to an endbell of an electric motor or to a stator frame of an electric motor.

The multi-phase converter may be attached to the electric motor in any suitable manner. In some examples, the multi-phase converter may be secured to a housing of the electric motor via bolts and/or brackets. Additionally or alternatively, adhesives and/or thermal pads may be used to couple the multi-phase converter to the electric motor.

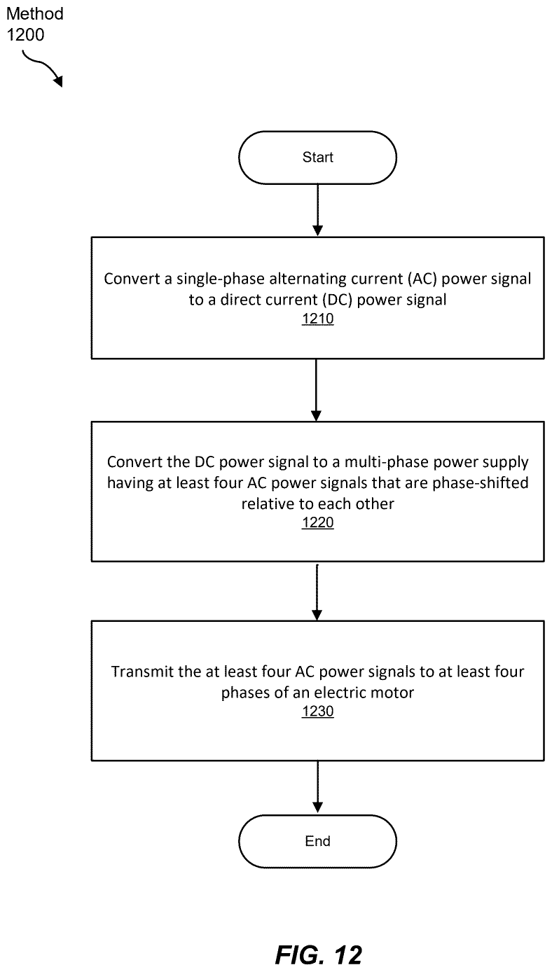

FIG. 12 shows a method for converting a single-phase AC power signal to a multiphase AC power signal and providing multiphase power signal to an electric motor. At step 121, a DC to AC converter converts a single-phase alternating current (AC) power signal to a direct current (DC) power signal. At step 1220, an AC to DC converter converts the DC power signal to a multi-phase power supply having at least four AC power signals that are phase-shifted relative to each other. At step 1230, the DC to AC converter transmits the at least four AC power signals to at least four phases of an electric motor.

The converters disclosed herein may be configured to power any suitable type or form of electric motor. In some examples, the converters disclosed herein may power asynchronous motors, such as induction motors (e.g., squirrel cage induction motors, wound rotor induction motors, etc.). Alternatively, the converters disclosed herein may power synchronous motors (e.g., permanent-magnet synchronous motors, reluctance motors, hysteresis motors, etc.). In other examples, the converters disclosed herein may power devices, other than motors, that require multi-phase power.

Example 1. An electric motor system comprising: an alternating current (AC) to direct current (DC) converter configured to convert a single-phase AC power signal to a DC power signal; a DC to AC converter coupled to the AC to DC converter and configured to change the DC power signal to a multi-phase power source having at least four AC power signals that are phase-shifted relative to each other; an electric motor having at least four phases, wherein each phase in the at least four phases is electrically coupled to an output that provides of one of the four AC power signals from the DC to AC converter.

Example 2. The electric motor system of Example 1, wherein the electric motor comprises an asynchronous motor.

Example 3. The electric motor system of one or more of Examples 1-2, wherein the electric motor comprises a synchronous motor.

Example 4. The electric motor system of one or more of Examples 1-3, wherein: the DC to AC converter is configured to change the DC power signal to a multi-phase power supply by changing the DC power signal to six AC power signals that are phase shifted relative to each other; and the electric motor has at least six phases, wherein each phase in the at least six phases is electrically coupled to an output that provides one of the six AC power signals from the DC to AC converter.

Example 5. The electric motor system of one or more of Examples 1-4, wherein the DC to AC converter comprises two three-phase inverters configured to have 30 degrees of electrical separation from each other.

Example 6. The electric motor system of one or more of Examples 1-5, wherein the AC to DC converter comprises a single-phase rectifier with power-factor correction.

Example 7. The electric motor system of Example 1-6, wherein the AC to DC converter comprises an active front end configured to enable the electric motor to function as an electric generator.

Example 8. The electric motor system of one or more of Examples 1-7, wherein the AC to DC converter and the DC to AC converter are mechanically coupled to a housing of the electric motor.

Example 9. A method comprising: coupling an alternating current (AC) to direct current (DC) converter to a DC to AC converter, wherein: the AC to DC converter is configured to convert a single-phase AC power signal to a DC power signal; the DC to AC converter is configured to change the DC power signal to a multi-phase power supply having at least four AC power signals that are phase-shifted relative to each other; and coupling the multi-phase power supply to an electric motor by coupling each output that provides one of the at least four AC power signals to a different phase of the electric motor.

Example 10. The method of Example 9, wherein the electric motor comprises an asynchronous motor.

Example 11. The method of one or more of Examples 9-10, wherein the electric motor comprises a synchronous motor.

Example 12. The method of one or more of Examples 9-11, wherein the DC to AC converter is configured to change the DC power signal to a multi-phase power supply by changing the DC power signal to six AC power signals that are phase shifted relative to each other.

Example 13. The method of one or more of Examples 9-12, wherein the DC to AC converter comprises two three-phase inverters configured to have 30 degrees of electrical separation from each other.

Example 14. The method of one or more of Examples 9-13, wherein the AC to DC converter comprises a single-phase rectifier with power-Factor correction.

Example 15. The method of one or more of Examples 9-14, wherein the AC to DC converter comprises an active front end configured to enable the electric motor to function as an electric generator.

Example 16. The method of one or more of Examples 9-15, further comprising mechanically coupling the DC to AC converter and the AC to DC converter to a housing of the electric motor.

Example 17. A method comprising: converting a single-phase alternating current (AC) power signal to a direct current (DC) power signal; converting the DC power signal to a multi-phase power supply having at least four AC power signals that are phase-shifted relative to each other; transmitting the at least four AC power signals to at least four phases of an electric motor.

Example 18. The method of Example 17, wherein the electric motor comprises an asynchronous motor.

Example 19. The method of one or more of Examples 17-18, wherein the electric motor comprises a synchronous motor.

Example 20. The method of one or more of Examples 17-19, wherein converting the DC power signal to the AC power signal comprises changing the DC power signal to six AC power signals that are phase shifted relative to each other.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An electric motor system comprising:
an alternating current (AC) to direct current (DC) converter configured to convert a single-phase AC power signal to a DC power signal;
a DC to AC converter coupled to the AC to DC converter and configured to change the DC power signal to a multi-phase power source having at least four AC power signals that are phase-shifted relative to each other;
an electric motor having at least four phases, wherein each phase in the at least four phases is electrically coupled to an output that provides of one of the four AC power signals from the DC to AC converter.

2. The electric motor system of claim 1, wherein the electric motor comprises an asynchronous motor.

3. The electric motor system of claim 1, wherein the electric motor comprises a synchronous motor.

4. The electric motor system of claim 1, wherein:
the DC to AC converter is configured to change the DC power signal to a multi-phase power supply by changing the DC power signal to six AC power signals that are phase shifted relative to each other; and
the electric motor has at least six phases, wherein each phase in the at least six phases is electrically coupled to an output that provides one of the six AC power signals from the DC to AC converter.

5. The electric motor system of claim 4, wherein the DC to AC converter comprises two three-phase inverters configured to have 30 degrees of electrical separation from each other.

6. The electric motor system of claim 1, wherein the AC to DC converter comprises a single-phase rectifier with power-factor correction.

7. The electric motor system of claim 1, wherein the AC to DC converter comprises an active front end configured to enable the electric motor to function as an electric generator.

8. The electric motor system of claim 1, wherein the AC to DC converter and the DC to AC converter are mechanically coupled to a housing of the electric motor.

9. A method comprising:
coupling an alternating current (AC) to direct current (DC) converter to a DC to AC converter, wherein:
the AC to DC converter is configured to convert a single-phase AC power signal to a DC power signal;
the DC to AC converter is configured to change the DC power signal to a multi-phase power supply having at least four AC power signals that are phase-shifted relative to each other; and
coupling the multi-phase power supply to an electric motor by coupling each output that provides one of the at least four AC power signals to a different phase of the electric motor.

10. The method of claim 9, wherein the electric motor comprises an asynchronous motor.

11. The method of claim 9, wherein the electric motor comprises a synchronous motor.

12. The method of claim 9, wherein the DC to AC converter is configured to change the DC power signal to a multi-phase power supply by changing the DC power signal to six AC power signals that are phase shifted relative to each other.

13. The method of claim 12, wherein the DC to AC converter comprises two three-phase inverters configured to have 30 degrees of electrical separation from each other.

14. The method of claim 9, wherein the AC to DC converter comprises a single-phase rectifier with power-factor correction.

15. The method of claim 9, wherein the AC to DC converter comprises an active front end configured to enable the electric motor to function as an electric generator.

16. The method of claim 9, further comprising mechanically coupling the DC to AC converter and the AC to DC converter to a housing of the electric motor.

17. A method comprising:
converting a single-phase alternating current (AC) power signal to a direct current (DC) power signal;
converting the DC power signal to a multi-phase power supply having at least four AC power signals that are phase-shifted relative to each other;
transmitting the at least four AC power signals to at least four phases of an electric motor.

18. The method of claim 17, wherein the electric motor comprises an asynchronous motor.

19. The method of claim 17, wherein the electric motor comprises a synchronous motor.

20. The method of claim 17, wherein converting the DC power signal to the AC power signal comprises changing the DC power signal to six AC power signals that are phase shifted relative to each other.
